(19) United States
(12) Patent Application Publication
(10) Pub. No.: US 2011/0250026 A1
(43) Pub. Date: Oct. 13, 2011

(54) DISPLAY STRUCTURE OF A DRILLING MACHINE

(76) Inventor: Shun Sheng Lin, Dali City (TW)

(21) Appl. No.: 12/766,020

(22) Filed: Apr. 23, 2010

(30) Foreign Application Priority Data
Apr. 9, 2010 (TW) 099206298

(51) Int. Cl. B23B 49/00

(52) U.S. Cl. 408/16

(57) ABSTRACT

A display structure of a drilling machine includes a digital display control assembly which includes a liquid crystal control panel, a control circuit board, a displacement induction controller and a battery seat. The liquid crystal control panel is electrically connected with the control circuit board. The control circuit board is electrically connected with the displacement induction controller. The control circuit board is further electrically connected with the battery seat. The displacement induction controller includes an engaging protrusion to engage with a displacement control linking seat of a feed guide body. The liquid crystal control panel of the digital display control assembly is adapted to input control signals, such as an initial point, a terminal point and a feed unit, and the control signals are sent to the displacement induction controller via the control circuit board. The displacement induction controller receives the signals and returns the signals to the control circuit board for controlling the upward/downward movement of the feed guide body. After setting the digital display control assembly, the feed guide body can carry out the same feed many times, controlling the feed depth and providing uniformity of drilling.

### BACKGROUND OF THE INVENTION

1. Field of the Invention

The present invention relates to a display structure of a drilling machine.

2. Description of the Prior Art

As shown in FIG. 8, a conventional drilling machine comprises a feed device (30), a driving control unit (40) and a main base (50). The feed device (30) comprises a drilling head (31). The main base (50) comprises a support rod (51) which is slideably connected with a stand (510). The stand (510) can be adjusted upward or downward relative to the support rod (51). The driving control unit (40) and the feed device (30) are disposed on top of the support rod (51) of the main base (50). The driving control unit (40) drives the driving head (31) of the feed device (30) to feed and drill. However, the conventional drilling machine has some shortcomings:

1. Lack of controllability: The driving control unit drives the driving head of the feed device to feed and drill. The feed depth of the feed device is controlled manually, which doesn't have a good controllability for the feed depth.
2. Lack of uniformity: The driving control unit drives the driving head of the feed device to feed and drill. The feed depth of the feed device is controlled manually. The depth of drilling may have a difference after drilling many times. There is a lack of uniformity in drilling.

Accordingly, the inventor of the present invention has devoted himself based on his many years of practical experiences to improve the aforesaid problems of the conventional drilling machine.

### SUMMARY OF THE INVENTION

The primary object of the present invention is to provide a display structure of a drilling machine which comprises a digital display control assembly. The digital display control assembly comprises a liquid crystal control panel, a control circuit board, a displacement induction controller and a battery seat. The liquid crystal control panel is electrically connected with the control circuit board. The control circuit board is electrically connected with the displacement induction controller. The control circuit board is further electrically connected with the battery seat. The displacement induction controller includes an engaging protrusion to engage with a displacement control linking seat of a feed guide body. The liquid crystal control panel of the digital display control assembly is adapted to input control signals, such as an initial point, a terminal point and a feed unit, and the control signals are sent to the displacement induction controller via the control circuit board. The displacement induction controller receives the signals and returns the signals to the control circuit board for controlling the upward/downward movement of the feed guide body. After setting the digital display control assembly, the feed guide body can carry out the same feed many times, controlling the feed depth and providing uniformity of drilling.

### BRIEF DESCRIPTION OF THE DRAWINGS

FIG. 1 is a partially perspective view according to a first embodiment of the present invention;

FIG. 2 is a partially exploded view according to the first embodiment of the present invention;

FIG. 3 is a perspective view with a portion exploded according to the first embodiment of the present invention;

FIG. 4 is a schematic view showing the drilling machine in an advancing operation according to the first embodiment of the present invention;

FIG. 5 is a schematic view showing the drilling machine in a retracting operation according to the first embodiment of the present invention;

FIG. 6 is a front view according to the first embodiment of the present invention;

FIG. 7 is a partially exploded view according to a second embodiment of the present invention; and

FIG. 8 is a perspective view of a conventional drilling machine.

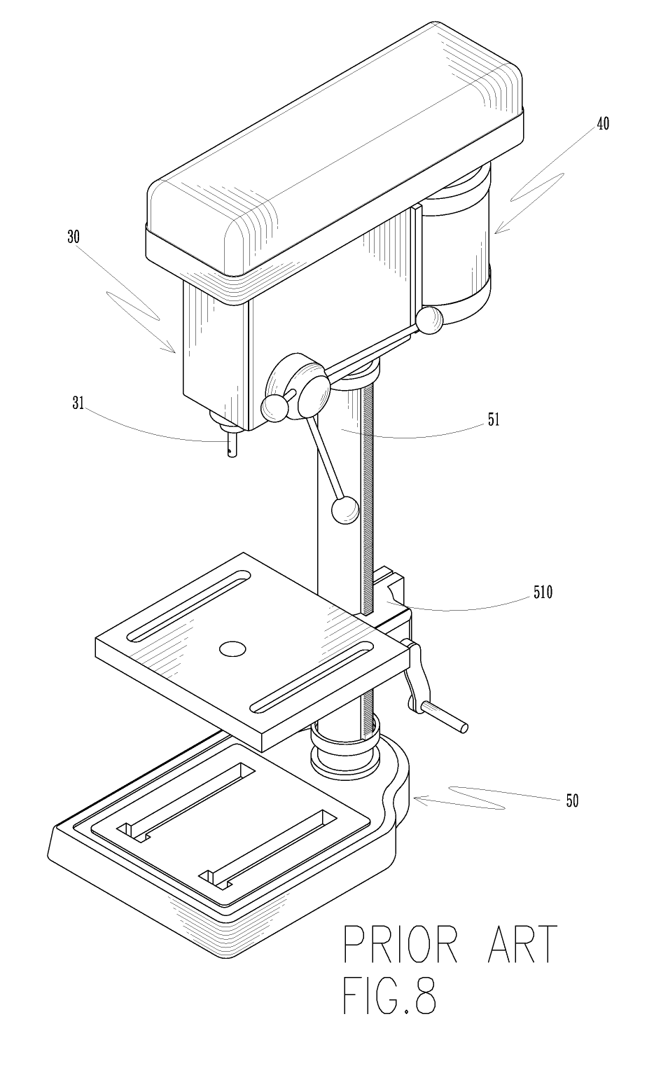

### DETAILED DESCRIPTION OF THE PREFERRED EMBODIMENTS

Embodiments of the present invention will now be described, by way of example only, with reference to the accompanying drawings.

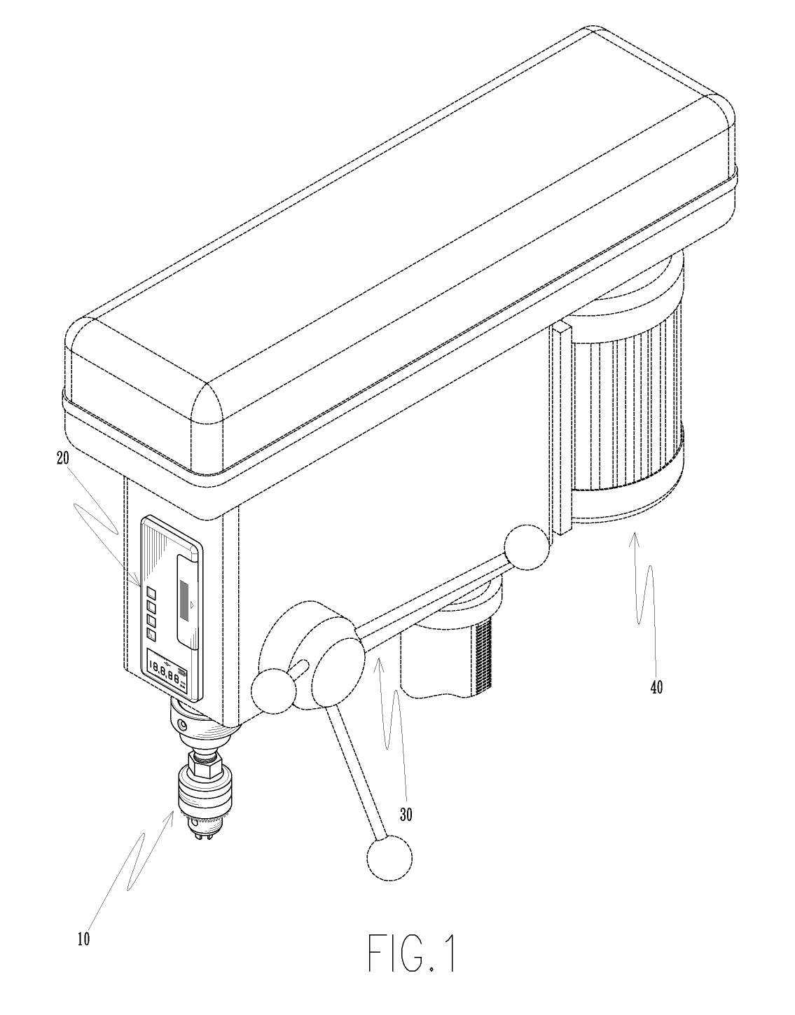

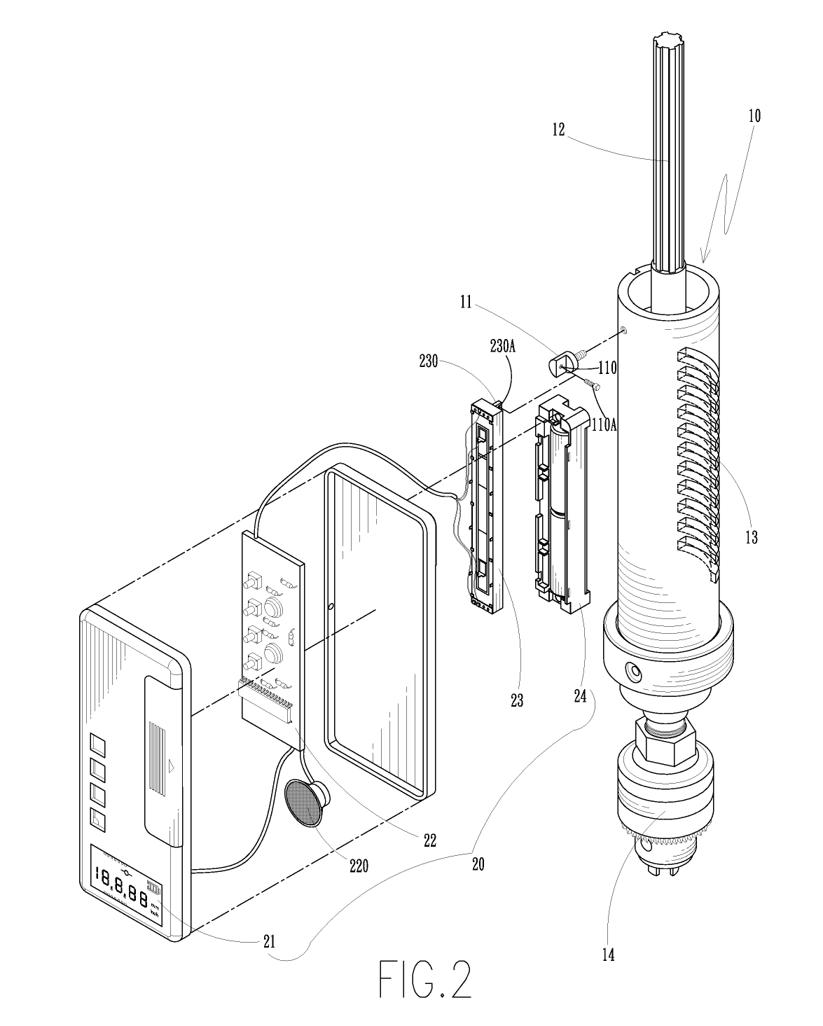

As shown in FIG. 1 and FIG. 2, a display structure of a drilling machine according to a first embodiment of the present invention comprises a feed guide body (10) and a digital display control assembly (20).

The feed guide body (10) comprises a displacement control linking seat (11) at a front side thereof. The displacement control linking seat (11) in a semi-cylinder shape has a first connecting hole (110) for insertion of a connecting member (110A). A guide spindle (12) is provided on top of feed guide body (10). The feed guide body (10) has a plurality of engaging portions (13) which are transversely disposed on a rear side of the feed guide body (10). The feed guide body (10) comprises a drilling head locking portion (14) at a lower end thereof.

The digital display control assembly (20) comprises a liquid crystal control panel (21), a control circuit board (22), a displacement induction controller (23), and a battery seat (24). The control circuit board (22) is electrically connected with a buzzer (220). The displacement induction controller (23) comprises an engaging protrusion (230) which has a second connecting hole (230A). The liquid crystal control panel (21) is electrically connected with the control circuit board (22). The control circuit board (22) is electrically connected with the displacement induction controller (23). The control circuit board (22) is also electrically connected with the battery seat (24). The engaging protrusion (230) of the displacement induction controller (23) is engaged with the displacement control linking seat (11) of the feed guide body (10). The second connecting hole (230A) of the engaging protrusion (230) is aligned with the first connecting hole (110) of the displacement control linking seat (11) of the feed guide body (10) and locked by the connecting member (110A). Accordingly, the display structure of the drilling machine of the present invention is assembled.

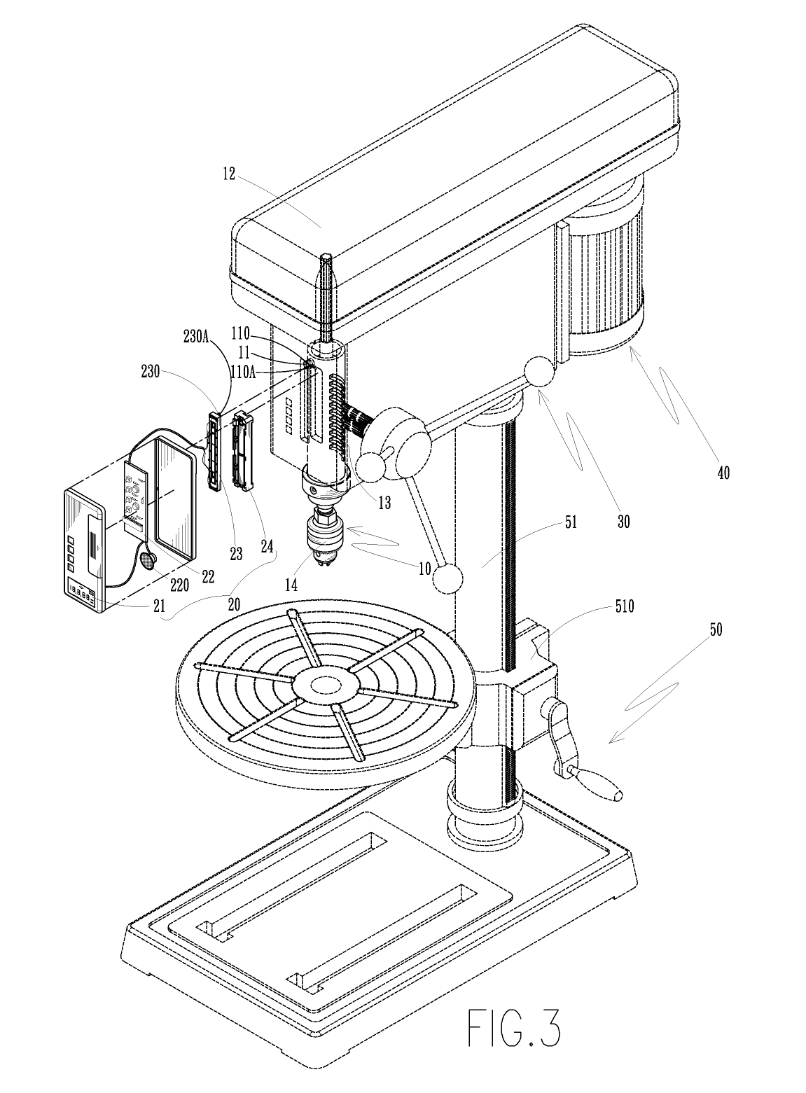

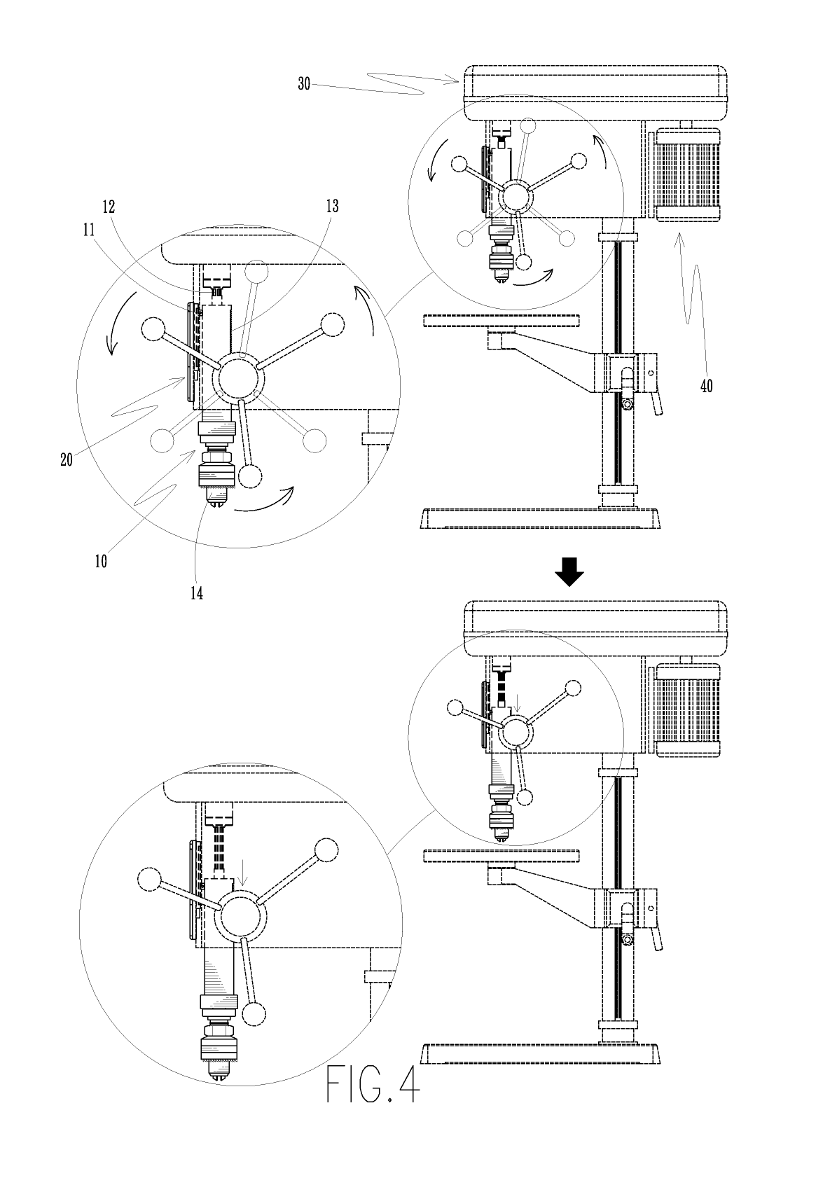

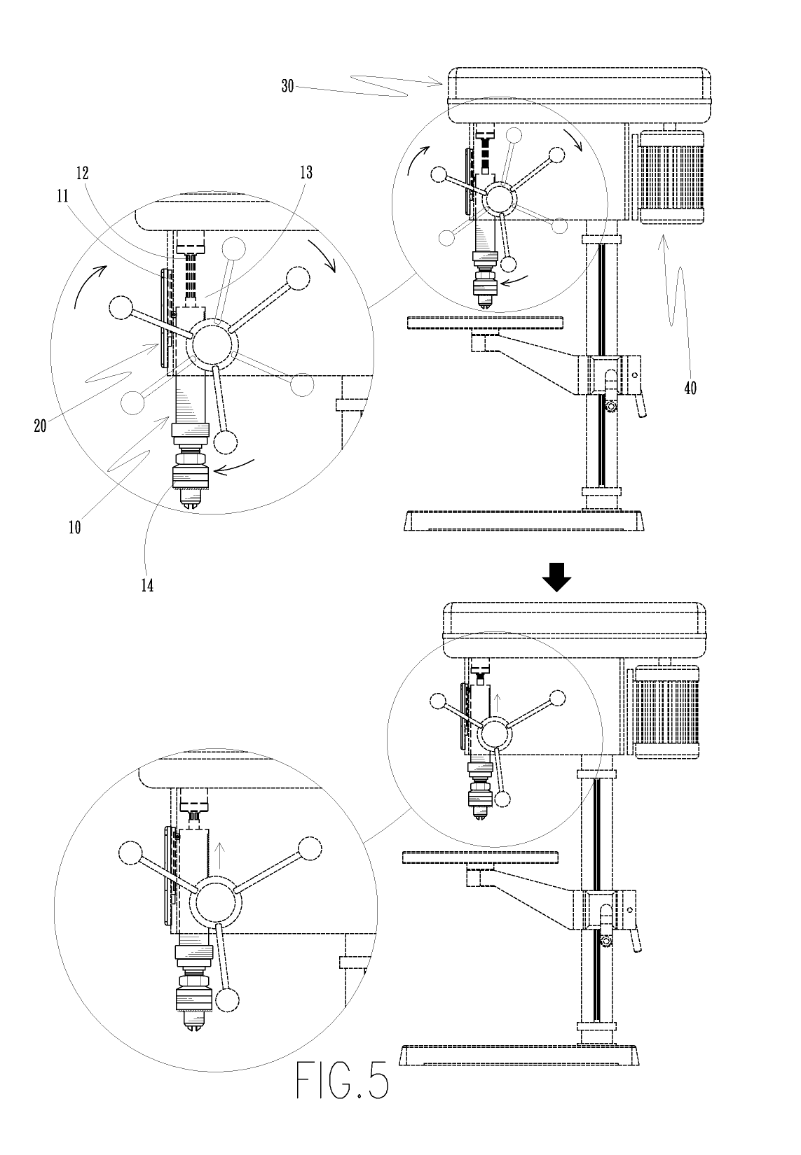

FIG. 3 is a partially exploded view of the display structure of the drilling machine of the present invention. FIG. 4 is a schematic view showing the drilling machine in an advancing operation. FIG. 5 is a schematic view showing the drilling machine in a retracting operation. The feed guide body (10) and the digital display control assembly (20) are coupled to a feed device (30). The feed device (30) is connected with a driving control unit (40) and a main base (50). The main body (50) comprises a support rod (51) which is provided with a movable stand (510). The driving control unit (40) drives the guide spindle (12) of the feed guide body (10). The liquid crystal control panel (21) is electrically connected with the control circuit board (22). The control circuit board (22) is electrically connected with the displacement induction controller (23). The control circuit board (22) is also electrically connected with the battery seat (24). The engaging protrusion (230) of the displacement induction controller (23) is engaged with the displacement control linking seat (11) of the feed guide body (10). The liquid crystal control panel (21) of the digital display control assembly (20) is adapted to input control signals, such as an initial point, a terminal point and a feed unit, and the control signals are sent to the displacement induction controller (23) via the control circuit board (22). The displacement induction controller (23) receives the signals and returns the signals to the control circuit board (22) for controlling the upward/downward movement of the feed guide body (10). After setting the digital display control assembly (20), the feed guide body (10) can carry out the same feed many times, controlling the feed depth well and providing uniformity of drilling.

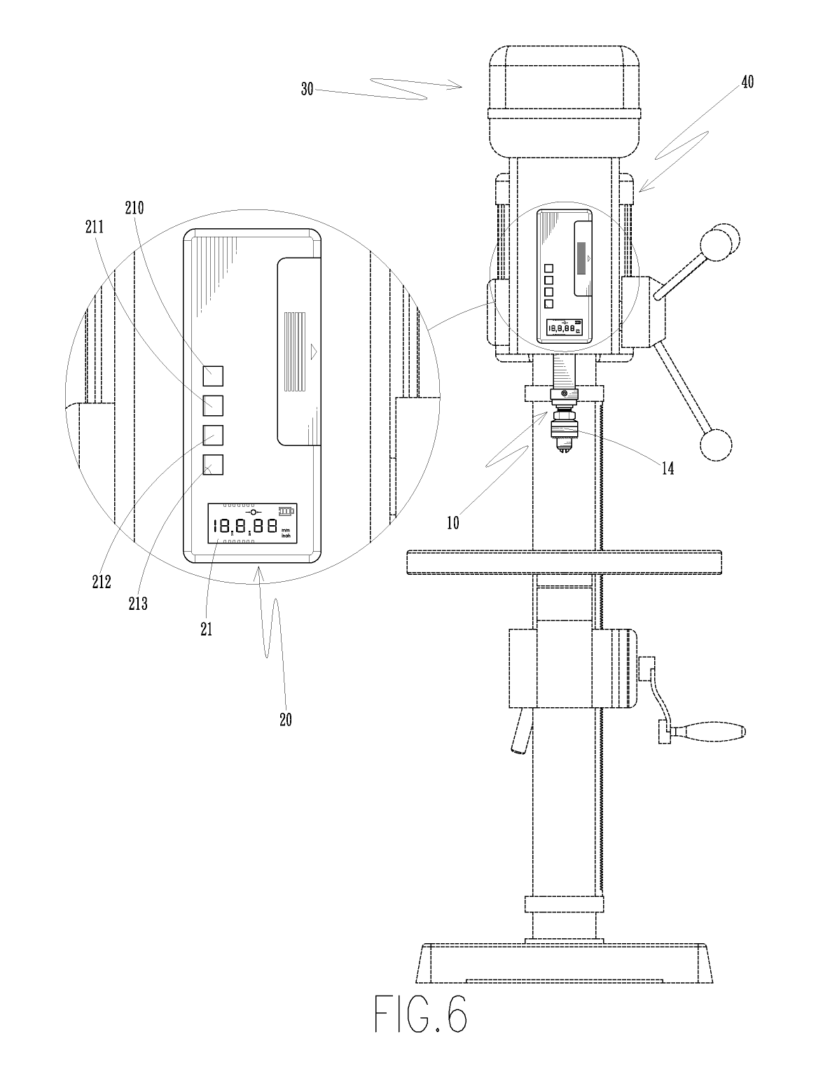

FIG. 6 is a front view showing the display structure of the drilling machine of the present invention coupled with the digital display control assembly (20). The liquid crystal control panel (21) of the digital display control assembly (20) further comprises a start switch (210), a feed unit control switch (211), an initial point switch (212) and a terminal point switch (213). The start switch (210) is pressed to turn on/off the machine. The start switch (210) is pressed for three seconds to delete the memory. The feed unit control switch (211) is pressed to select the feed unit in millimeter of inch. The initial point switch (212) and the terminal point switch (213) are adapted to set the feed depth of the feed guide body (10).

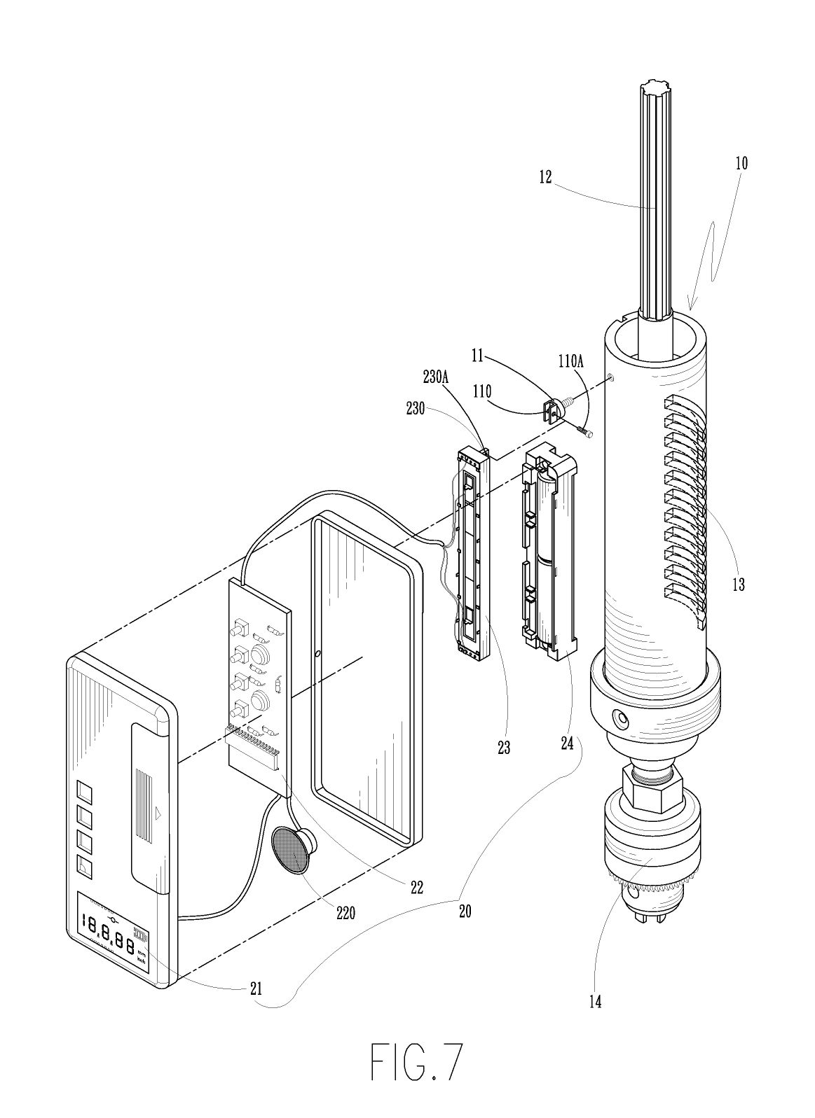

FIG. 7 shows the display structure of the drilling machine according to a second embodiment of the present invention, which is substantially similar to the first embodiment as shown in FIG. 1 to FIG. 6 with the exceptions described hereinafter. The displacement control linking seat (11) of the feed guide body (10) is in a U shape and has a pair of first connecting holes (110) at two sides thereof for insertion of the connecting member (110A). The U-shaped displacement control linking seat (11) is adapted to engage with the engaging protrusion (230) of the displacement induction controller (23). The pair of first connecting holes (110) of the displacement control linking seat (11) of the feed guide body (10) is aligned with the second connecting hole (230A) of the engaging protrusion (230) and locked by the connecting member (110A).

The present invention has some advantages as follows:
1. Providing a better controllability for the feed depth: The liquid crystal control panel of the digital display control assembly is adapted to input the control signals, such as the initial point, the terminal point and the feed unit, and the control signals are sent to the displacement induction controller via the control circuit board. The displacement induction controller receives the signals and returns the signals to the control circuit board for controlling the upward/downward movement of the feed guide body.
2. Providing uniformity of drilling: After setting the digital display control assembly, the feed guide body can carry out the same feed many times.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A display structure of a drilling machine, comprising:
a feed guide body, the feed guide body comprising a displacement control linking seat; and
a digital display control assembly, the digital display control assembly comprising a liquid crystal control panel, a control circuit board and a displacement induction controller, the displacement induction controller comprising an engaging protrusion, the liquid crystal control panel being electrically connected with the control circuit board, the control circuit board being electrically connected with the displacement induction controller, the control circuit board being further electrically connected with a power source, the engaging protrusion of the displacement induction controller being engaged with the displacement control linking seat of the feed guide body.

2. The display structure of a drilling machine as claimed in claim 1, wherein the displacement control linking seat is disposed at a front side of the feed guide body.

3. The display structure of a drilling machine as claimed in claim 1, wherein a guide spindle is provided on top of the feed guide body.

4. The display structure of a drilling machine as claimed in claim 1, wherein the feed guide body has a plurality of engaging portions which are transversely disposed on a rear side of the feed guide body.

5. The display structure of a drilling machine as claimed in claim 1, wherein the feed guide body comprises a drilling head locking portion at a lower end thereof.

6. The display structure of a drilling machine as claimed in claim 1, wherein the power source is a battery seat which is electrically connected with the control circuit board.

7. The display structure of a drilling machine as claimed in claim 1, wherein the control circuit board is electrically connected with a buzzer.

8. The display structure of a drilling machine as claimed in claim 1, wherein the liquid crystal control panel comprises a start switch, a feed unit control switch, an initial point switch and a terminal point switch.

9. The display structure of a drilling machine as claimed in claim 1, wherein the displacement control linking seat in a semi-cylinder shape has a first connecting hole for insertion of a connecting member, the engaging protrusion of the displacement induction controller having a second connecting hole, the second connecting hole of the engaging protrusion of the displacement induction controller being aligned with the first connecting hole of the displacement control linking seat and locked by the connecting member.

10. The display structure of a drilling machine as claimed in claim 1, wherein the displacement control linking seat in a U shape has a pair of first connecting holes at two sides thereof for insertion of a connecting member, the engaging protrusion of the displacement induction controller having a second connecting hole, the pair of first connecting holes of the displacement control linking seat being aligned with the second connecting hole of the engaging protrusion of the displacement induction controller and locked by the connecting member.
